(19) United States
(12) Patent Application Publication
(10) Pub. No.: US 2024/0311193 A1
(43) Pub. Date: Sep. 19, 2024

(54) METHOD AND APPARATUS FOR ALLOCATING COMPUTING TASK OF NEURAL NETWORK IN HETEROGENEOUS RESOURCES, AND DEVICE

(71) Applicant: Suzhou Metabrain Intelligent Technology Co., Ltd., Suzhou, Jiangsu (CN)

(72) Inventors: Rengang LI, Suzhou, Jiangsu (CN); Lu LIU, Suzhou, Jiangsu (CN); Yaqian ZHAO, Suzhou, Jiangsu (CN); Zhenhua GUO, Suzhou, Jiangsu (CN); Ruidong YAN, Suzhou, Jiangsu (CN); Cong XU, Suzhou, Jiangsu (CN); Liang JIN, Suzhou, Jiangsu (CN)

(21) Appl. No.: 18/571,650

(22) PCT Filed: Apr. 28, 2022
(86) PCT No.: PCT/CN2022/090020

§ 371 Date: Dec. 18, 2023

(30) Foreign Application Priority Data
Nov. 4, 2021 (CN) 202111297679.1

(51) Int. Cl. G06F 9/50

(52) U.S. Cl. CPC G06F 9/5027; G06F 2209/5017

(57) ABSTRACT

A method and apparatus for allocating a computing task of a neural network in heterogeneous resources, a computer device, and a storage medium. The method includes: acquiring task information of the computing task of the neural network and resource information of the heterogeneous resources; determining, according to the task information and the resource information, an allocation mode for allocating each subtask to the heterogeneous resources for execution and a task processing cost corresponding to each allocation mode; constructing a directed acyclic graph according to each allocation mode and each task processing cost; obtaining a value of a loss function corresponding to each allocation path according to the task processing cost corresponding to each subtask in an allocation path of the directed acyclic graph; and selecting a target allocation path according to the value of each loss function.

This application claims priority to Chinese Patent Application No. 202111297679.1, filed on Nov. 4, 2021 in China National Intellectual Property Administration and entitled “METHOD AND APPARATUS FOR ALLOCATING COMPUTING TASK OF NEURAL NETWORK IN HETEROGENEOUS RESOURCES, AND DEVICE”, which is hereby incorporated by reference in its entirety.

### FIELD

The present application relates to the technical field of computers, in particular, to a method and apparatus for allocating a computing task of a neural network in heterogeneous resources, a computer device, and a storage medium.

### BACKGROUND

Deep neural networks, such as Convolutional Neural Networks (CNNs) and Transformer networks, have been widely used in an image processing, a speech recognition, a natural language processing, and other fields. A deep neural network is composed of multiple layers of neurons. An output of a previous layer serves as an input of a next layer for subsequent computation. A deep neural network computation is performed on a batch data basis and is suitable for being performed in a heterogeneous unit. Whether in forward computation or back computation, the network combines a batch of inputs/outputs for processing to improve computation efficiency. At present, due to applicability of a Graphics Processing Unit (GPU) for high-throughput digital processing, it has become a common practice to use a data parallel method on the GPU to improve the network training speed. In addition, a Field Programmable Gate Array (FPGA) is suitable for running tasks with high power consumption.

The inventors have realized that in traditional technical solutions, task allocation of a neural network is generally aimed at minimizing a memory. This allocation mode is only applicable to task allocation of the same kind of resources, with a small application scope, and the traditional method also has certain limitations in allocation accuracy.

### SUMMARY

In one or more aspects, the present application provides a method for allocating a computing task of a neural network in heterogeneous resources. The method includes:
acquiring task information of the computing task of the neural network and resource information of the heterogeneous resources configured for executing the computing task, the computing task including a plurality of subtasks;
determining, according to the task information and the resource information, at least two allocation modes for allocating each subtask to the heterogeneous resources for execution and a task processing cost corresponding to each allocation mode;
constructing a directed acyclic graph according to each allocation mode and each task processing cost, the directed acyclic graph including a corresponding allocation path when each subtask is allocated to the heterogeneous resource for execution;
obtaining a value of a loss function corresponding to each allocation path according to the task processing cost corresponding to each subtask in each allocation path; and
selecting a target allocation path according to the value of the loss function corresponding to each allocation path.

In one or more embodiments, the task processing cost includes an execution cost and a communication cost; the task information includes a task execution sequence and task identifiers between each subtask; the resource information includes a running speed of each resource among the heterogeneous resources; and the determining, according to the task information and the resource information, at least two allocation modes for allocating each subtask to the heterogeneous resources for execution and a task processing cost corresponding to each allocation mode includes:
obtaining each allocation mode by allocating a resource to each subtask in sequence according to the task execution sequence;
determining the execution cost corresponding to each allocation mode according to the running speed of each resource and a task identifier of each subtask;
determining, according to the task execution sequence, a layer of the neural network to which the resource allocated to each subtask belongs; and
generating the communication cost according to the layer of the neural network to which each resource belongs and a preset quantity of pieces of data transmitted between each layer of the neural network, the communication cost being a transmission cost of transmitting an execution result of each subtask to a next layer.

In one or more embodiments, the constructing a directed acyclic graph according to each allocation mode and each task processing cost includes:
creating a current node, the current node being a node corresponding to a task execution operation for allocating a current subtask to a current resource for execution, and a weight of the current node being the execution cost when the current subtask is executed by the current resource;
acquiring a next subtask identifier according to the task execution sequence;
creating a next node, the next node being a node corresponding to a task execution operation for allocating a subtask corresponding to the next subtask identifier to a next resource for execution, and a weight of the next node being the execution cost when the next subtask is executed by the next resource;
creating an edge between the current node and the next node, a weight of the edge being a communication cost when the current subtask is executed by the current resource; and
when the next subtask is not the last subtask, returning to a step of acquiring the next subtask identifier according to the task execution sequence.

In one or more embodiments, the method further includes:
when it is determined, according to the task execution sequence, that the current subtask is a first task, the current node being a start node of the directed acyclic graph, replacing a weight of the start node with a first preset weight; and
when the current subtask is a last task, the current node being an end node of the directed acyclic graph, replacing a weight of the end node with a second preset weight.

In one or more embodiments, the obtaining a value of a loss function corresponding to each allocation path according to the task processing cost corresponding to each subtask in each allocation path includes:
determining a sum of a weight of each node in each allocation path and a weight of each edge, and obtaining the value of the loss function corresponding to each allocation path.

In one or more embodiments, the method further includes:
performing a relaxation operation on each node to obtain a newly added edge corresponding to each node, a weight of the newly added edge being a weight of a corresponding node; and
the obtaining a value of a loss function corresponding to each allocation path according to the task processing cost corresponding to each subtask in each allocation path includes:
determining a sum of a weight of each edge in each allocation path and a weight of each newly added edge, and obtaining the value of the loss function corresponding to each allocation path.

In one or more embodiments, the selecting a target allocation path according to the value of the loss function corresponding to each allocation path includes:
selecting an allocation path with the minimum value of the loss function as the target allocation path.

In another aspect, the present application provides an apparatus for allocating a computing task of a neural network in heterogeneous resources. The apparatus includes:
an acquisition module, configured for acquiring task information of the computing task of the neural network and resource information of the heterogeneous resources configured for executing the computing task, the computing task including a plurality of subtasks;
an allocation module, configured for determining, according to the task information and the resource information, at least two allocation modes for allocating each subtask to a heterogeneous resource for execution and a task processing cost corresponding to each allocation mode;
a construction module, configured for constructing a directed acyclic graph according to each allocation mode and each task processing cost, the directed acyclic graph including a corresponding allocation path when each subtask is allocated to the heterogeneous resource for execution;
a processing module, configured for obtaining a value of a loss function corresponding to each allocation path according to the task processing cost corresponding to each subtask in each allocation path; and
a selection module, configured for selecting a target allocation path according to the value of the loss function corresponding to each allocation path.

In yet another aspect, the present application provides a computer device, including a memory, one or more processors, and computer-readable instructions stored on the memory and runnable on the processors. The processors execute the computer-readable instructions to implement steps of the method for allocating the computing task of the neural network in the heterogeneous resources, provided in any one of the above embodiments.

In still another aspect, the present application provides one or more non-volatile computer-readable storage media configured for storing computer-readable instructions. The computer-readable instructions, when executed by one or more processors, cause the one or more processors to implement steps of the method for allocating the computing task of the neural network in the heterogeneous resources, provided in any one of the above embodiments.

Details of one or more embodiments of the present application will be proposed in the following accompanying drawings and descriptions. Other features and advantages of the present application will become apparent from the specification, the accompanying drawings and the claims.

### BRIEF DESCRIPTION OF THE DRAWINGS

FIG. 1 is a diagram of an application environment of a method for allocating a computing task of a neural network in heterogeneous resources, provided according to one or more embodiments of the present application;

FIG. 2 is a flowchart of a method for allocating the computing task of the neural network in the heterogeneous resources, provided according to the one or more embodiments of the present application;

FIG. 3 is a flowchart of constructing a directed acyclic graph according to each allocation mode and each task processing cost, provided according to the one or more embodiments of the present application;

FIG. 4 is a schematic diagram of the directed acyclic graph provided according to the one or more embodiments of the present application;

FIG. 5 is a schematic diagram of the directed acyclic graph after performing a relaxation operation on a node, provided according to the one or more embodiments of the present application;

FIG. 6 is a block structural diagram of an apparatus for allocating the computing task of the neural network in the heterogeneous resources, provided according to the one or more embodiments of the present application; and

FIG. 7 is a diagram of an internal structure of a computer device provided according to the one or more embodiments of the present application.

### DETAILED DESCRIPTION

In order to make objectives, technical solutions and advantages of the present application clearer, the present application is further described below in detail with reference to accompanying drawings and embodiments. It should be understood that the embodiments described here are merely to explain the present application, and not intended to limit the present application.

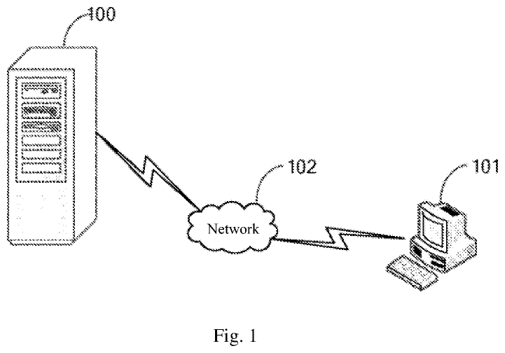

Please refer to FIG. 1, FIG. 1 is a diagram of an application environment of a method for allocating a computing task of a neural network in heterogeneous resources, provided according to an exemplary embodiment of the present application. As shown in FIG. 1, the present application environment includes an allocation server 100 and a scheduling server 101. The allocation server 100 and the scheduling server 101 achieves a communicable connection through a network 102, so as to implement the method for allocating the computing task of the neural network in the heterogeneous resources.

The server 100 is configured for acquiring task information of the computing task and resource information of the heterogeneous resources configured for executing the computing task, the computing task including a plurality of subtasks, determining, according to the task information and the resource information, at least two allocation modes for allocating each subtask to the heterogeneous resources for execution and a task processing cost corresponding to each allocation mode, constructing a directed acyclic graph according to each allocation mode, each task processing cost, and a pre-trained neural network model, the directed acyclic graph including a corresponding allocation path when each subtask is allocated to the heterogeneous resource for execution, obtaining a value of a loss function corresponding to each allocation path according to the task processing cost corresponding to each subtask in each allocation path, and selecting a target allocation path according to the value of the loss function corresponding to each allocation path. The server 100 can be implemented as an independent server or as a server cluster composed of a plurality of servers.

The scheduling server 101 is configured for acquiring the target allocation path from the allocation server 100 and performing task scheduling according to the target allocation path. The scheduling server 101 can be implemented as an independent server or as a server cluster composed of a plurality of servers.

The network 102 is configured for achieving network connection between the scheduling server 101 and the server 100. In one or more embodiments, the network 102 may include various types of wired or wireless networks.

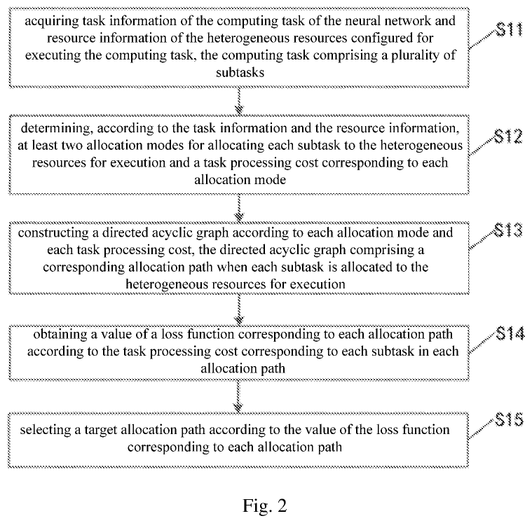

In one or more embodiments, as shown in FIG. 2, a method for allocating a computing task of a neural network in heterogeneous resources is provided. The above method includes: acquiring task information of the computing task of the neural network and resource information of the heterogeneous resources configured for executing the computing task, the computing task including a plurality of subtasks, determining, according to the task information and the resource information, at least two allocation modes for allocating each subtask to the heterogeneous resources for execution and a task processing cost corresponding to each allocation mode, constructing a directed acyclic graph according to each allocation mode and each task processing cost, the directed acyclic graph including a corresponding allocation path when each subtask is allocated to the heterogeneous resource for execution, obtaining a value of a loss function corresponding to each allocation path according to the task processing cost corresponding to each subtask in each allocation path, and selecting a target allocation path according to the value of the loss function corresponding to each allocation path. In the present application, the subtasks are used as an allocation granularity, and each subtask is allocated to different kinds of resources, that is, the present application is applicable to task allocation between heterogeneous resources. The application range is wider than that of the traditional technology.

Application of the method to the servers in FIG. 1 is taken as an example for explanation below. The method includes:
S11: acquiring task information of the computing task of the neural network and resource information of the heterogeneous resource configured for executing the computing task, the computing task including a plurality of subtasks.

In the present application, the heterogeneous resources may use forward propagation computation when processing the computational task of the neural network. A basic calculation idea of the forward propagation computation is that the neural network is composed of multiple layers of neurons, and an output of a previous layer is used as an input of a next layer for subsequent computation. In one or more embodiments, each neuron receives an input from another neuron on the previous layer, calculates a weighted sum of the input, and outputs a final result through an activation function as an input of a neuron on the next layer. The input data and the data obtained via intermediate calculation flow through a network until they an output node. Therefore, when the computing task of the neural network is executed, an input of a next computing task needs to use an output of a previous computing task.

In another implementation, the computing task of the neural network may also use back propagation computation. The computing task of the neural network is carried out on a batch data basis, which is suitable for being performed in the heterogeneous resources. Whether in the forward propagation computation or the back propagation computation, the network combines a batch of inputs/outputs for processing to improve the computation efficiency.

The present application further includes following steps:
dividing the computing task of the neural network into a plurality of subtasks according to a pre-trained neural network model. In one or more embodiments, the computing task is divided according to layers of the neural network model. That is, a quantity of the subtasks obtained by dividing the computing task is equal to a quantity of the layers of the neural network. An i^{th} layer of the neural network model after division executes an i^{th} subtask.

The above task information may include a task identifier of each subtask in the computing task, a task execution sequence between each subtask, a task content, and the like. The above heterogeneous resources may include a plurality of processors with different forms in computing resources, such as a central processing unit (CPU), a graphics processing unit (GPU), and a field programmable gate array (FPGA). For example, for a personal computer with a GPU, a CPU and the GPU on the system have form heterogeneous computing resources. The above resource information may include a resource type, resource identifier, running speed, and the like of each resource. The resource type may be, for example, CPU, GPU, and FPGA. In the present application, each subtask in the computing task needs to be allocated to each resource among the heterogeneous resources for processing. Therefore, the present application provides a method for allocating a computing task of a neural network in heterogeneous resources to obtain an optimal target allocation path.
S12: determining, according to the task information and the resource information, at least two allocation modes for allocating each subtask to a heterogeneous resource for execution and a task processing cost corresponding to each allocation mode.

In the present application, the aforementioned heterogeneous resources may include a plurality of processors with different forms. The server allocates each subtask to the resources for processing. When the i^{th} subtask is allocated to resource Y for execution, the i^{th} layer of the neural network model executes the subtask on the resource Y.

In the present application, the above allocation mode is a mode for allocating each subtask to each resource. For example, the computing task includes three subtasks: A1, A2, and A3, while the heterogeneous resources include two resources: B1 and B2. There are six allocation modes for the subtasks:
In a first allocation mode: A1 is allocated to B1;
in a second allocation mode: A1 is allocated to B2;
in a third allocation mode: A2 is allocated to B1;
in a fourth allocation mode: A2 is allocated to B2;
in a fifth allocation mode: A3 is allocated to B1; and
in a sixth allocation mode: A3 is allocated to B2.

There is a corresponding task processing cost for each of the above allocation modes. The present application determines the task processing cost corresponding to each allocation mode according to the task information and the resource information. For example, for the above first allocation mode, corresponding task processing cost M1 may be calculated according to the task information of A1 and the resource information of B1. Similarly, for the second allocation mode, corresponding task processing cost M2 may also be calculated. By parity of reasoning, the task processing costs for all the allocation modes are calculated, so six corresponding task processing costs may be obtained: M1, M2, M3, M4, M5, and M6.

In the present application, the above task information may include information such as a quantity of subtasks, a task identifier of each subtask, and the task content of each subtask. The above resource information may include a quantity of resources, a resource identifier of each resource, a resource type of each resource, a running speed of each resource, other attribute information of the resources, and the like. The resource type of each resource may be, for example, CPU, GPU, and FPGA.

S13: constructing a directed acyclic graph according to each allocation mode and each task processing cost, the directed acyclic graph including a corresponding allocation path when each subtask is allocated to the heterogeneous resource for execution.

In the present application, the above directed acyclic graph is a directed graph without a loop. The above directed acyclic graph may include a plurality of nodes and a plurality of edges. A node corresponds to a computing operation when a subtask is allocated to a resource for execution. An edge corresponds to a data movement operation of transmitting, to a next resource, an output generated when a subtask is executed by a resource.

It may be understood that each allocation mode mentioned above corresponds to a computing operation for task execution. Therefore, each allocation mode corresponds to one node. Under each allocation mode, when each subtask is executed by the resource, an output result may be generated. The output result needs to be transmitted to the next resource as an input for a next subtask processing process. Therefore, there will be a corresponding data movement process, that is, the above edge. In summary, one allocation mode will correspond to one node and one edge. That is, one node and one edge may be created correspondingly according to each allocation mode.

Further, the above example is continuously taken as an example. When the computing task includes three subtasks: A1, A2, and A3, and the heterogeneous resources include two resources: B1 and B2, there are six allocation modes. A1 corresponds to two allocation modes, A2 corresponds to two allocation modes, and A3 corresponds to two allocation modes. The allocation mode of each subtask is combined into an allocation path of the entire computing task. The general allocation path includes 2*2*2=8 allocation paths. Therefore, the above directed acyclic graph includes the eight allocation paths.
S14: obtaining a value of a loss function corresponding to each allocation path according to the task processing cost corresponding to each subtask in each allocation path.

In the present application, the value of a loss function is generated for each allocation path. The loss function is a sum of task processing costs generated on each allocation path. In the above example, the computing task includes three subtasks: A1, A2, and A3, while the heterogeneous resources include two resources: B1 and B2. One allocation path is A1B1-A2B2-A3B1. The sum of the task processing costs corresponding to this allocation path is M1+M4+M5. Therefore, the value of the loss function corresponding to the allocation path is M1+M4+M5. By parity of reasoning, the values of the loss functions corresponding to the respective allocation paths may be calculated.
S15: selecting a target allocation path according to the value of the loss function corresponding to each allocation path.

In the heterogeneous computing resources, training of the neural network may be seen as a process of minimizing the loss function. Therefore, the present application selects the target allocation path according to a purpose of minimizing the value of the loss function. However, the value of the loss function in the present application is equal to the sum of the total task processing costs corresponding to each subtask in the allocation path. Therefore, the above target allocation path may be selected according to the minimum sum of the total task processing costs corresponding to each subtask in the allocation path.

In summary, the present application divides the computing task into the plurality of subtasks according to the layers of the neural network model, and allocates the plurality of subtasks to the various resources among the heterogeneous resources, whereby the heterogeneous resources may execute each subtask. This achieves the allocation of the task of the neural network in the heterogeneous resources, improves the task allocation granularity, and expands present application scope of the solution. In addition, the present application selects the optimal target allocation path on the basis of an optimization goal of minimizing the cost, whereby when the tasks are scheduled according to the target allocation path, the task processing cost is minimized, which theoretically improves the task processing efficiency.

In one or more embodiments, the above task processing cost includes an execution cost and a communication cost. The task information includes the task execution sequence of each subtask and the task identifier of each subtask. The resource information includes a running speed of each resource among the heterogeneous resources. And the determining, according to the task information and the resource information, at least two allocation modes for allocating each subtask to the heterogeneous resources for execution and a task processing cost corresponding to each allocation mode may include:
determining the execution cost corresponding to each allocation mode according to the running speed of each resource and the task identifier of each subtask;
determining, according to the task execution sequence, a layer of the neural network to which the resource allocated to each subtask belongs; and
generating the communication cost according to the layer of the neural network to which each resource belongs and a preset quantity of pieces of data transmitted between each layer of the neural network, the communication cost being a transmission cost of transmitting an execution result of each subtask to a next layer.

In the present application, the above execution cost may be execution consumption time when the resource executes the subtask. An output of one task in the computing task of the neural network needs to be used as an input for execution of a next task, the above communication cost may be transmission consumption time of transmitting the output of one subtask to a next resource. The above task identifier may be identifier information set by the server for each subtask in advance.

In one or more embodiments, it is assumed that each task is composed of N subtasks t₁, . . . , t_{N}, and the execution of each subtask follows the task execution sequence. An output of subtask tᵢ is an input of subtask tᵢ₊₁, and there are dᵢ pieces of data that are transferred to task tᵢ₊₁. The system includes R computing units r₁, . . . , r_{R}, and subtask t may be executed in any computing resource r at an execution cost of c(t, r). A mapping relationship between subtasks and resources is m(t)=r, indicating that subtask t is allocated to resource r for execution.

It is assumed that the running speed of resource r is v and tᵢ is a subtask identifier, the execution cost is c(t, r)=f(v, tᵢ). Therefore, the present application determines the execution cost corresponding to each allocation mode according to c(t, r)=f(v, tᵢ).

The determining, according to the task execution sequence, a layer of the neural network to which the resource allocated to each subtask belongs may include:
when a current subtask is a first executed task, the resource that executes the subtask is the first layer of the neural network. When the current subtask is a second executed task, the resource that executes the subtask is the second layer of the neural network, and so on, until the layer of the neural network to which the last resource belongs is determined.

Further, a quantity of data transmitted between the layers of the above neural network is preset. It is assumed that f(i, j) represents the communication cost of transmitting one unit of data from a computing resource, and there are a total of di data transmitted in subtask tᵢ, the communication cost of executing subtask tᵢ is dᵢf(m(tᵢ), m(tᵢ₊₁)). The present application calculates the execution cost and communication cost when the subtask is executed according to this expression.

In another implementation, the present application may also calculate a sum of the execution costs corresponding to each allocation path and a sum of the communication costs corresponding to each allocation path. In one or more embodiments, the sum of the execution costs corresponding to each allocation path is:

$${\sum }_{i = 1}^{N} ( {t}_{i} , m ( {t}_{i} ) )$$

the sum of the communication costs corresponding to each allocation path is:

$${\sum }_{i = 1}^{N - 1} {d}_{i} , f ( m ( {t}_{i} ) , m ( {t}_{i + 1} ) )$$

The application selects an optimal target allocation path on the basis of minimizing the sum of the execution costs and the sum of the communication costs. Task allocation performed according to the target allocation path may minimize the final task processing cost, shorten the task execution time to the largest extent, and improve the task execution efficiency.

In one or more embodiments, the constructing a directed acyclic graph according to each allocation mode and each task processing cost may include:
creating a current node, the current node being a node corresponding to a task execution operation for allocating a current subtask to a current resource for execution, and a weight of the current node being an execution cost when the current subtask is executed by the current resource;
acquiring a next subtask identifier according to the task execution sequence;
creating a next node, the next node being a node corresponding to a task execution operation for allocating a subtask corresponding to the next subtask identifier to a next resource for execution, and a weight of the next node being an execution cost when the next subtask is executed by the next resource;
creating an edge between the current node and the next node, a weight of the edge being a communication cost when the current subtask is executed by the current resource; and
when the next subtask is not the last subtask, returning to the step of acquiring a next subtask identifier according to the task execution sequence.

The server returns to a step of acquiring a next subtask identifier according to the task execution sequence in response to a fact that the next subtask is not the last subtask.

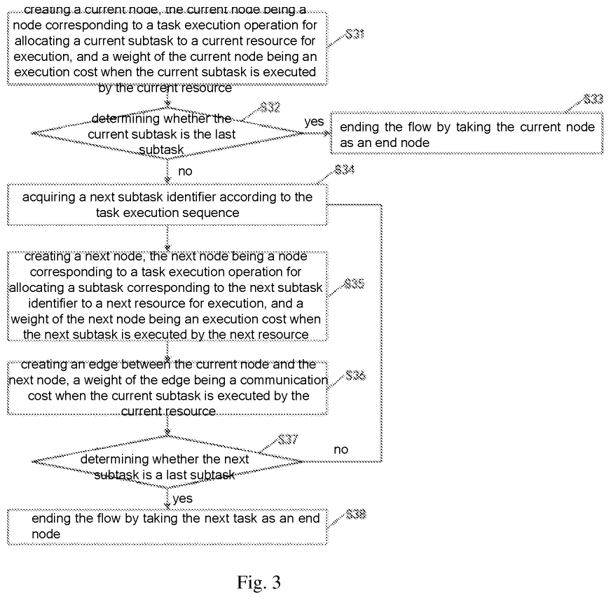

Please refer to FIG. 3 providing a flowchart of detailed steps of constructing a directed acyclic graph according to each allocation mode and each task processing cost in one or more embodiments. As shown in FIG. 3, in one or more embodiments, the constructing a directed acyclic graph according to each allocation mode and each task processing cost may include:
S31: creating a current node, the current node being a node corresponding to a task execution operation for allocating a current subtask to a current resource for execution, and a weight of the current node being an execution cost when the current subtask is executed by the current resource;
S32: determining whether the current subtask is the last subtask;
S33: if yes, ending the flow by taking the current node as an end node;
S34: if no, acquiring a next subtask identifier according to the task execution sequence;
S35: creating a next node, the next node being a node corresponding to a task execution operation for allocating a subtask corresponding to the next subtask identifier to a next resource for execution, and a weight of the next node being an execution cost when the next subtask is executed by the next resource;
S36: creating an edge between the current node and the next node, a weight of the edge being a communication cost when the current subtask is executed by the current resource; and
S37: determining whether the next subtask is the last subtask, and returning, if the next task is not a last task, a step of acquiring a next subtask identifier according to the task execution sequence; and
S38: if the next task is a last task, ending the flow by taking the next task as an end node.

In the present application, the above directed acyclic graph includes a plurality of nodes and a plurality of edges. The above nodes are configured for representing computing operations when the subtasks are executed by the resources. The above edges are configured for representing data movement operations of transmitting, to next resources, outputs generated when the subtasks are executed by the resources.

The present application constructs a directed acyclic graph G(V, E).

A node set is V={v_{i,j}|1≤i≤N, 1≤j≤R}.

An edge set is E={(v_{i,j}, v_{i+1,k})|1≤i≤N, 1≤j,k≤R}, where k represents a k^{th} resource, namely, there are a total of NR nodes. That is, there are N groups of nodes. Each node corresponds to a subtask, and each group includes R nodes. Each node corresponds to one resource. Further, each node in an i^{th} task group is connected to each node in an (i+1)^{th} node group.

After the directed acyclic graph is constructed, the nodes and edges in the directed graph need to be weighted. The weight of node v_{i,j} is c(tᵢ, j), which represents that subtask tᵢ that being executed is operated on computing resource j, and the weight c(tᵢ, j) of the node represents the execution cost. The weight of edge (v_{i,j}, v_{i+1,k}) is dif(j, k), which represents the communication cost between the i^{th} subtask and the (i+1)^{th} subtask, and the subtasks are calculated on resources i and k, respectively.

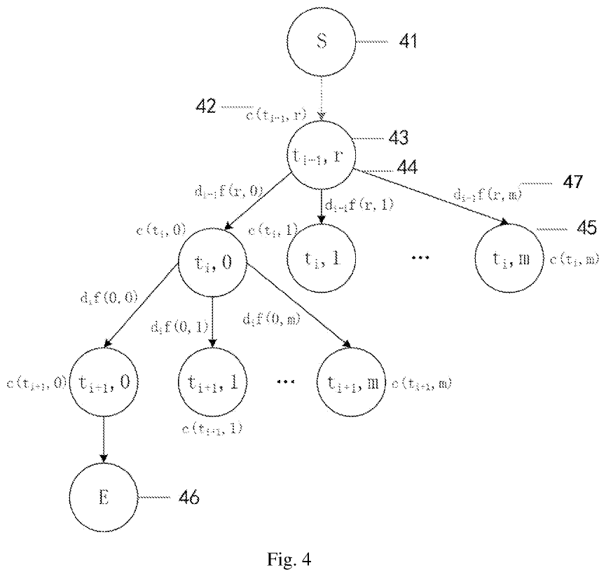

Please refer to FIG. 4, in one or more embodiments, the present application provides a schematic diagram of the directed acyclic graph. As shown in FIG. 4, the directed acyclic graph includes start node 41, node 43, weight 42 of node 43, node 45, edge 44 between node 43 and node 45, weight 47 of edge 44, and end node 46.

Start node 41 is S, and weight 42 of node 43 is equal to c(tᵢ₋₁, r). The weight represents the execution cost when subtask tᵢ₋₁ is allocated to resource r for execution. Weight 47 of edge 44 is equal to dᵢ₋₁f(r; m). The weight represents the communication cost of transmitting an output result of node 43 to a resource corresponding to node 45. From FIG. 4, it may be seen that when an allocation path is selected, each node on the allocation path has an execution cost and a communication cost.

For example, in the above example, the computing task includes three subtasks: A1, A2, and A3, while the heterogeneous resources include two resources: B1 and B2. There are six allocation modes for the subtasks:
In the first allocation mode S1: A1 is allocated to B1;
in the second allocation mode S2: A1 is allocated to B2;
in the third allocation mode S3: A2 is allocated to B1;
in the fourth allocation mode S4: A2 is allocated to B2;
in the fifth allocation mode S5: A3 is allocated to B1; and
in the sixth allocation mode S6: A3 is allocated to B2.

Since each allocation mode corresponds to one subtask being executed by one resource, there will be a corresponding computing operation under this allocation mode. Therefore, one node needs to be created for each allocation mode. One node is created for allocation mode S1 mentioned above. One node is created for allocation mode S2 mentioned above. And by parity of reasoning, six nodes need to be created in this example.

In one or more embodiments, one allocation path A1B1-A2B2-A3B1 is taken as an example, which includes three nodes A1B1, A2B2, and A3B1. In addition, the allocation path also includes two edges. The first node A1B1 represents that subtask A1 is allocated to resource B1 for execution. The server calculates an execution cost of node A1B1, and the execution cost is the weight of node A1B1. An output of A1B1 needs to be transmitted to second node A2B2 as an input. In this process, a communication cost will be generated. The communication cost is the weight of the edge between node A1B1 and node A2B2.

The present application constructs the directed acyclic graph on the basis of the execution cost and the communication cost to select the optimal target allocation path, whereby the selected target allocation path has the lowest task processing cost, and the selection of the allocation path is more intuitive.

In one or more embodiments, the method may further include:
when it is determined, according to the task execution sequence, that the current subtask is a first task, the current node being a start node of the directed acyclic graph, replacing a weight of the start node with a first preset weight; and
when the current subtask is a last task, the current node being an end node of the directed acyclic graph, replacing a weight of the end node with a second preset weight.

The server replaces the weight of the start node with the first preset weight in response to when it is determined, according to the task execution sequence, that the current subtask is the first task, the current node being the start node of the directed acyclic graph.

The server replaces the weight of the end node with the second preset weight in response to when the current subtask is a last task, the current node being the end node of the directed acyclic graph.

In the present application, the first preset weight and the second preset weight may be set to be 0. In order to simplify the calculation of the first preset weight and the second preset weight mentioned above, other values may also be set.

In order to simplify the labeling, the present application adds two nodes with weights of 0, representing the start node and the end node of the computation of the neural network. The start node is linked to all nodes of the first subtask, and all final subtasks will be linked to the end node with a weight of 0. By introducing the start end and end node with the weights of 0, the present application simplifies the computation and improves the generation efficiency of the target allocation path.

In one or more embodiments, the obtaining a value of a loss function corresponding to each allocation path according to the task processing cost corresponding to each subtask in each allocation path may include:
determining a sum of a weight of each node in each allocation path and a weight of each edge, and obtaining the value of the loss function corresponding to each allocation path.

In the present application, an expression of the loss function may be the following expression (1-1):

$$C = {\sum }_{i = 1}^{N} ( {t}_{i} , m ( {t}_{i} ) ) + {\sum }_{i = 1}^{N - 1} {d}_{i} f ( m ( {t}_{i} ) , m ( {t}_{i + 1} ) ) \qquad ( 1 - 1 )$$

where C above represents the loss function.

The above

$${\sum }_{i = 1}^{N} ( {t}_{i} , m ( {t}_{i} ) )$$

represents the sum of the execution cost of each subtask during execution, or may be understood as the sum of the execution costs generated when each subtask in one allocation path in the directed acyclic graph is executed.

The above

$${\sum }_{i = 1}^{N - 1} {d}_{i} f ( m ( {t}_{i} ) , m ( {t}_{i + 1} ) )$$

represents the sum of the communication costs generated when each subtask in one allocation path in the directed acyclic graph is executed.

From expression (1-1), it may be seen that the value of the loss function is equal to the sum of the execution cost corresponding to each subtask in the allocation path plus the sum of the communication costs. The weight of each node in each allocation path is equal to the execution costs corresponding to the subtasks, and the weight of each edge is equal to the communication costs corresponding to the subtasks. The value of the loss function corresponding to each allocation path may be obtained by determining a sum of the weight of each node in each allocation path and the weight of each edge.

In one or more embodiments, the method may further include:
performing a relaxation operation on each node to obtain a newly added edge corresponding to each node, a weight of the newly added edge being a weight of a corresponding node.

The obtaining a value of a loss function corresponding to each allocation path according to the task processing cost corresponding to each subtask in each allocation path may include:
determining a sum of the weight of each edge in each allocation path and the weight of each newly added edge, and obtaining the value of the loss function corresponding to each allocation path.

In the present application, a relaxation operation is performed on each node. Each node may be transformed into two nodes, and a newly added edge may be obtained. The weight of the newly added edge is equal to the weight of the corresponding node before transformation, whereby the weight of each node may be expanded to the weight of the edge. When the value of the loss function of each allocation path is subsequently calculated after the relaxation operation is performed on each node, it is necessary to calculate the sum of the weights of the respective edges, so as to better adapt to a shortest path algorithm.

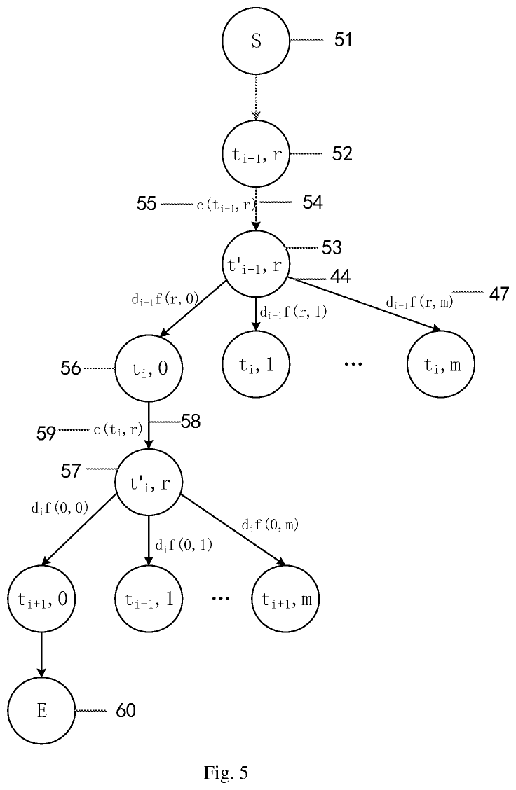

Please refer to FIG. 5, a schematic diagram of a directed acyclic graph after performing a relaxation operation on a node is provided in one or more embodiments. As shown in FIG. 5, the directed acyclic graph obtained after the relaxation operation is performed on the node includes start node 51, newly added nodes 52 and 53 after relaxation, newly added edge 54 between newly added node 52 and newly added node 53, weight 55 of newly added edge 54, newly added nodes 56 and 57 after relaxation, newly added edge 58 between newly added node 56 and newly added node 57, weight 59 of the newly added edge 58, and end node 60. The weight of newly added edge 54 is the weight of the corresponding original node before relaxation. The weight of newly added edge 58 is the weight of the corresponding original node before relaxation. The present application expands each original node into two nodes and a newly added edge through the relaxation operation, and assigns the weight of the original node to the newly added edge, whereby the weight of the node may be transformed into the weight of the edge, so as to better calculate the value of the loss function.

In one or more embodiments, the selecting a target allocation path according to the value of the loss function corresponding to each allocation path may include:
selecting an allocation path with a minimum value of the loss function as the target allocation path.

In the present application, after the directed acyclic graph is constructed, the shortest path in the graph may be calculated according to the breadth-first algorithm. In one or more embodiments, starting from a vertex, all reachable nodes are found, and the weight of the edge on each allocation path is recorded, and the searching is stopped until an end point is searched. Sums of the total processing costs after the computing task is calculated by the respective layers of the neural network are obtained, and the allocation path with the smallest sum of the total processing costs is the target allocation path.

In the present application, the training process of the neural network in the heterogeneous computing resources may be regarded as a process of minimizing the loss function C(0, r), as follows:

$$C ( 0 , r ) \qquad ( 1 - 2 )$$

$$C ( i , r ) = {min}_{j = 1}^{R} ( C ( i - 1 , j ) + {d}_{i - 1} f ( j , r ) + c ( {t}_{j} , r ) ) \qquad ( 1 - 3 )$$

$$C = {min}_{j = 1}^{R} C ( N , j ) \qquad ( 1 - 4 )$$

The above expression (1-2) represents the value of the loss function corresponding to a start layer of the neural network. The above expression (1-3) represents the value of the loss function corresponding to an i^{th} layer of the neural network, and the above expression (1-4) represents the value of the loss function corresponding to an N^{th} layer of the neural network.

Based on the training principle of the above neural network, the present application may select the optimal target path from each allocation path by an optimization purpose of minimizing the value of the loss function, that is, the allocation path with the minimum value of the loss function is selected as the target distribution path.

In one or more embodiments, the above method may also include:
executing task scheduling according to the target allocation path; or
when a request for obtaining the target allocation path sent by the scheduling server, sending the target allocation path to the scheduling server, whereby the scheduling server executes task scheduling according to the target allocation path.

In one or more embodiments, the above method for allocating the computing task of the neural network in the heterogeneous resources may also be implemented by the following steps:
Step 1: initializing a heterogeneous system, and obtaining types and a quantity R of available resources in a computing system.
Step 2: inputting a current computing task, and randomly selecting a batch of data as the current computing task to calculate a weight on a directed acyclic graph.
Step 3: constructing a task-resource allocation graph, namely, the above directed acyclic graph, a quantity of layers of the neural network being i=0.
Step 4: allocating a computing resource m(tᵢ) to each subtask in the computing task, and calculating an execution time cost of an i^{th} layer in the neural network as c(tᵢ, m(tᵢ)).
Step 5: determining whether the i^{th} layer is the last layer; if not, continuing the computation; and if yes, proceeding to Step 8.
Step 6: calculating a communication cost dif(m(tᵢ), m(tᵢ+1)) for moving the batch of data to the computing resource.
Step 7: determining whether i^{th} layer is the last layer, if not, executing i=i+1 and proceeding to Step 4; if yes, continuing the computation.
Step 8: relaxing each node N in the task-resource allocation graph to expand the nodes into 2N nodes, a weight between nodes being c(tᵢ,m(tᵢ)).
Step 9: calculating the shortest path in the graph using the breadth-first algorithm, starting from a vertex, finding all reachable nodes, and recording the weight of an edge on the allocation path. And stopping the searching until an end point is searched. A sum of total task processing costs after this batch of data is calculated by each layer of the neural network is obtained, and a minimum sum corresponds to a target allocation scheme.

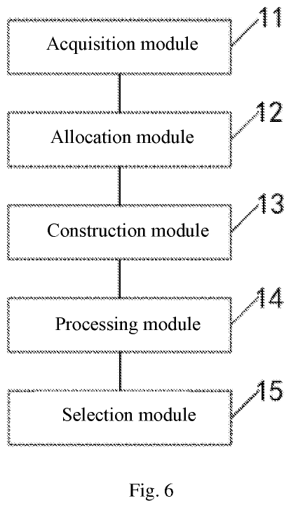

In one or more embodiments, as shown in FIG. 6, an apparatus for allocating a computer task of a neural network in heterogeneous resources is provided, including an acquisition module 11, an allocation module 12, a construction module 13, a processing module 14, and a selection module 15.

The acquisition module 11 is configured for acquiring task information of the computing task and resource information of the heterogeneous resources configured for executing the computing task, the computing task including a plurality of subtasks.

An allocation module 12 is configured for determining, according to the task information and the resource information, at least two allocation modes for allocating each subtask to the heterogeneous resources for execution and a task processing cost corresponding to each allocation mode.

The construction module 13 configured for constructing a directed acyclic graph according to each allocation mode, each task processing cost, and a pre-trained neural network model, the directed acyclic graph including a corresponding allocation path when each subtask is allocated to the heterogeneous resources for execution.

The processing module 14 is configured for obtaining a value of a loss function corresponding to each allocation path according to the task processing cost corresponding to each subtask in each allocation path.
the selection module 15 is configured for selecting a target allocation path according to the value of the loss function corresponding to each allocation path.

In one or more embodiments, the task processing cost includes an execution cost and a communication cost. The task information includes the task execution sequence of each subtask and the task identifier of each subtask. The resource information includes a running speed of each resource among the heterogeneous resources. And the above allocation module 12 may be configured for: obtaining each allocation mode by allocating a resource to each subtask in sequence according to the task execution sequence, determining the execution cost corresponding to each allocation mode according to the running speed of each resource and the task identifier of each subtask, determining, according to the task execution sequence, a layer of the neural network to which the resource allocated to each subtask belongs, and generating the communication cost according to the layer of the neural network to which each resource belongs and a preset quantity of pieces of data transmitted between each layer of the neural network, the communication cost being a transmission cost of transmitting an execution result of each subtask to a next layer.

In one or more embodiments, the construction module 13 may be configured for: creating a current node, the current node being a node corresponding to a task execution operation for allocating a current subtask to a current resource for execution, and a weight of the current node being an execution cost when the current subtask is executed by the current resource, acquiring a next subtask identifier according to the task execution sequence, creating a next node, the next node being a node corresponding to a task execution operation for allocating a subtask corresponding to the next subtask identifier to a next resource for execution, and a weight of the next node being an execution cost when the next subtask is executed by the next resource, creating an edge between the current node and the next node, a weight of the edge being a communication cost when the current subtask is executed by the current resource, and when the next subtask is not the last subtask, returning to a step of acquiring a next subtask identifier according to the task execution sequence.

In one or more embodiments, the above apparatus further includes a setting module (not shown). The setting module may be configured for: when it is determined, according to the task execution sequence, that the current subtask is a first task, the current node being a start node of the directed acyclic graph, replacing a weight of the start node with a first preset weight, and when the current subtask is a last task, the current node being an end node of the directed acyclic graph, replacing a weight of the end node with a second preset weight.

In one or more embodiments, the processing module 14 may be configured for determine a sum of a weight of each node in each allocation path and a weight of each edge, and obtain the value of the loss function corresponding to each allocation path.

In one or more embodiments, the above apparatus further includes a relaxation module (not shown). The relaxation module may be configured for performing a relaxation operation on each node to obtain a newly added edge corresponding to each node, a weight of the newly added edge being a weight of the corresponding node, and the processing module 14 may be configured for: determining a sum of a weight of each edge in each allocation path and a weight of each newly added edge, and obtaining the value of the loss function corresponding to each allocation path.

In one or more embodiments, the selection module 15 may be configured for selecting an allocation path with a minimum value of the loss function as the target allocation path.

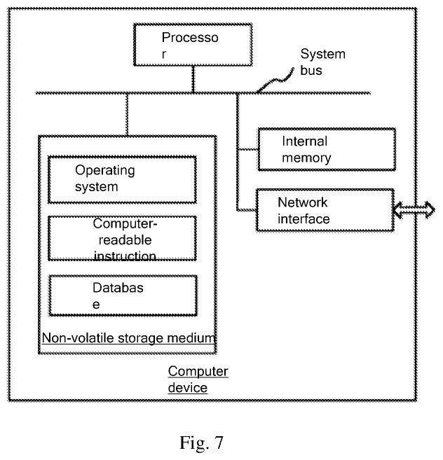

In one or more embodiments, a computer device is provided. The computer device may be a server. FIG. 7 shows a diagram of an internal structure of the computer device. The computer device includes a processor, a memory, a network interface and a database which are connected through a system bus. The processor of the computer device is configured to provide computing and control capabilities. The memory of the computer device includes a nonvolatile storage medium and an internal memory. The non-volatile storage medium stores an operating system, computer-readable instructions, and a database. The internal memory provides an environment for the running of the operating system and the computer-readable instructions in non-volatile storage medium. The database of the computer device is configured for storing data such as task information of a computing task of a neural network. The network interface of the computer device is configured for communicating with an external terminal through network connection. The computer-readable instructions, when executed by the processor, implements a method for allocating a computing task of a neural network in heterogeneous resources.

In one or more aspects, a computer device is provided, including a memory, one or more processors, and computer-readable instructions stored on the memory and runnable on the processors. The processors execute the computer-readable instructions to implement the steps of the method for allocating the computing task of the neural network in the heterogeneous resources, provided in any one of the above embodiments.

In another aspect, in one or more embodiments, the present application provides one or more non-volatile computer-readable storage media configured for storing computer-readable instructions. The computer-readable instructions, when executed by one or more processors, cause the one or more processors to implement the steps of the method for allocating the computing task of the neural network in the heterogeneous resources, provided in any one of the above embodiments.

Those of ordinary skill in the art may understand that implementation of all or a part of the flows in the method of the foregoing embodiment may be completed by the computer-readable instructions that instruct relevant hardware. The computer-readable instructions may be stored in a non-volatile computer-readable storage medium. The computer-readable instructions may include the flows of the embodiments of the foregoing methods when executed. Any reference to the memory, the storage, the database or other media used in the embodiments provided by the present application may include non-volatile and/or volatile memories. The non-volatile memories may include a read-only memory (ROM), a programmable ROM (PROM), an electrically programmable ROM (EPROM), an electrically erasable programmable ROM (EEPROM) or a flash memory. The volatile memories may include a random-access memory (RAM) or an external cache. As an illustration but not a limitation, the RAM is available in many forms, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), a Rambus direct RAM (RDRAM), a direct memory bus dynamic RAM (DRDRAM), and a memory bus dynamic RAM (RDRAM).

The technical features of the embodiments described above may be arbitrarily combined. In order to make the description concise, all possible combinations of various technical features in the above embodiments are not completely described. However, the combinations of these technical features should be considered as the scope described in the present specification as long as there is no contradiction in them.

The above embodiments express several implementations of the present application, and their descriptions are more specific and detailed, but they may not be understood as limiting the patent scope of the application. It should be noted that those of ordinary skill in the art may further make variations and improvements without departing from the conception of present application, and these variations and improvements fall within the protection scope of present application. Therefore, the patent protection scope of present application should be subject to the appended claims.

1. A method for allocating a computing task of a neural network in heterogeneous resources, comprising:
acquiring task information of the computing task of the neural network and resource information of the heterogeneous resources configured for executing the computing task, the computing task comprising a plurality of subtasks;
determining, according to the task information and the resource information, at least two allocation modes for allocating each subtask to the heterogeneous resources for execution and a task processing cost corresponding to each allocation mode;
constructing a directed acyclic graph according to each allocation mode and each task processing cost, the directed acyclic graph comprising a corresponding allocation path when each subtask is allocated to the heterogeneous resources for execution;
obtaining a value of a loss function corresponding to each allocation path according to the task processing cost corresponding to each subtask in each allocation path; and
selecting a target allocation path according to the value of the loss function corresponding to each allocation path.

2. The method according to claim 1, wherein the task processing cost comprises an execution cost and a communication cost, the task information comprises a task execution sequence and task identifiers between each subtask, the resource information comprises a running speed of each resource among the heterogeneous resources, and the determining, according to the task information and the resource information, at least two allocation modes for allocating each subtask to the heterogeneous resources for execution and a task processing cost corresponding to each allocation mode comprises:
obtaining each allocation mode by allocating a resource to each subtask in sequence according to the task execution sequence;
determining the execution cost corresponding to each allocation mode according to the running speed of each resource and a task identifier of each subtask;
determining, according to the task execution sequence, a layer of the neural network to which the resource allocated to each subtask belongs; and
generating the communication cost according to the layer of the neural network to which each resource belongs and a preset quantity of pieces of data transmitted between each layer of the neural network, the communication cost being a transmission cost of transmitting an execution result of each subtask to a next layer.

3. The method according to claim 2, wherein the constructing a directed acyclic graph according to each allocation mode and each task processing cost comprises:
creating a current node, the current node being a node corresponding to a task execution operation for allocating a current subtask to a current resource for execution, and a weight of the current node being the execution cost when the current subtask is executed by the current resource;
acquiring a next subtask identifier according to the task execution sequence;
creating a next node, the next node being a node corresponding to a task execution operation for allocating a subtask corresponding to the next subtask identifier to a next resource for execution, and a weight of the next node being the execution cost when the next subtask is executed by the next resource;
creating an edge between the current node and the next node, a weight of the edge being the communication cost when the current subtask is executed by the current resource; and
in response to a determination that the next subtask is not a last subtask, returning to a step of acquiring the next subtask identifier according to the task execution sequence.

4. The method according to claim 3, further comprising:
in response to a determination that, according to the task execution sequence, that the current subtask is a first task, the current node being a start node of the directed acyclic graph, replacing a weight of the start node with a first preset weight; and
in response to a determination that the current subtask is a last task, the current node being an end node of the directed acyclic graph, replacing a weight of the end node with a second preset weight.

5. The method according to claim 3, wherein the obtaining a value of a loss function corresponding to each allocation path according to the task processing cost corresponding to each subtask in each allocation path comprises:
determining a sum of a weight of each node in each allocation path and a weight of each edge, and obtaining the value of the loss function corresponding to each allocation path.

6. The method according to claim 3, wherein the method further comprises:
performing a relaxation operation on each node to obtain a newly added edge corresponding to each node, a weight of the newly added edge being a weight of a corresponding node; and
the obtaining a value of a loss function corresponding to each allocation path according to the task processing cost corresponding to each subtask in each allocation path comprises:
determining a sum of a weight of each edge in each allocation path and a weight of each newly added edge, and obtaining the value of the loss function corresponding to each allocation path.

7. The method according to claim 1, wherein the selecting a target allocation path according to the value of the loss function corresponding to each allocation path comprises:
selecting an allocation path with a minimum value of the loss function as the target allocation path.

8. (canceled)

9. A computer device, comprising:
a memory storing a computer program; and
one or more processors configured to execute the computer program, wherein the one or more processors, upon execution of the computer program, is configured to:
acquire task information of a computing task of a neural network and resource information of heterogeneous resources configured for executing the computing task, the computing task comprising a plurality of subtasks;
determine, according to the task information and the resource information, at least two allocation modes for allocating each subtask to the heterogeneous resources for execution and a task processing cost corresponding to each allocation mode:
construct a directed acyclic graph according to each allocation mode and each task processing cost, the directed acyclic graph comprising a corresponding allocation path when each subtask is allocated to the heterogeneous resources for execution;
obtain a value of a loss function corresponding to each allocation path according to the task processing cost corresponding to each subtask in each allocation path; and
select a target allocation path according to the value of the loss function corresponding to each allocation path.

10. One or more non-volatile computer-readable storage media configured for storing a computer program executable by a processor, and upon execution by the processor, is configured to cause the processor to:
acquire task information of a computing task of a neural network and resource information of heterogeneous resources configured for executing the computing task, the computing task comprising a plurality of subtasks:
determine, according to the task information and the resource information, at least two allocation modes for allocating each subtask to the heterogeneous resources for execution and a task processing cost corresponding to each allocation mode:
construct a directed acyclic graph according to each allocation mode and each task processing cost, the directed acyclic graph comprising a corresponding allocation path when each subtask is allocated to the heterogeneous resources for execution;
obtain a value of a loss function corresponding to each allocation path according to the task processing cost corresponding to each subtask in each allocation path; and
select a target allocation path according to the value of the loss function corresponding to each allocation path.

11. The method according to claim 1, wherein before the acquiring task information of the computing task of the neural network and resource information of the heterogeneous resources configured for executing the computing task, the computing task comprising a plurality of subtasks, comprising:
performing forward propagation computation or back propagation computation on the computing task according to a batch data basis.

12. The method according to claim 1, wherein before the acquiring task information of the computing task of the neural network and resource information of the heterogeneous resources configured for executing the computing task, the computing task comprising a plurality of subtasks, comprising:
obtaining layers of a pre-trained neural network model; and
dividing the computing task into the plurality of subtasks according to the layers.

13. The method according to claim 1, wherein the constructing a directed acyclic graph according to each allocation mode and each task processing cost, the directed acyclic graph comprising a corresponding allocation path when each subtask is allocated to the heterogeneous resources for execution comprises:
combining each allocation mode to obtain the allocation path.

14. The method according to claim 1, wherein the obtaining a value of a loss function corresponding to each allocation path according to the task processing cost corresponding to each subtask in each allocation path comprises:
obtaining a sum of task processing costs generated on each allocation path; and
taking the value for the loss function corresponding to each allocation path based on the sum of the task processing costs.

15. The method according to claim 2, wherein the execution cost comprises execution consumption time when each resource executes corresponding subtasks.

16. The method according to claim 3, wherein the communication cost comprises transmission consumption time of transmitting an output of a subtask to the next resource.

17. The method according to claim 2, wherein the determining, according to the task execution sequence, a layer of the neural network to which the resource allocated to each subtask belongs comprises:
determining an executed order of a current subtask; and
determining the layer of the neural network to which the resource allocated to each subtask belongs according to the executed order.

18. The method according to claim 2, wherein the constructing a directed acyclic graph according to each allocation mode and each task processing cost, the directed acyclic graph comprising a corresponding allocation path when each subtask is allocated to the heterogeneous resources for execution comprise:
minimizing a sum of the execution cost and the communication cost to filter out the target allocation path.

19. The method according to claim 3, wherein the acquiring a next subtask identifier according to the task execution sequence comprises:
determining whether the current subtask is the last subtask;
ending a process in response to a determination that the current subtask is the last subtask; and
acquiring the next subtask identifier according to the task execution sequence in response to a determination that the current subtask is not the last subtask.

20. The method according to claim 4, wherein the first preset weight and the second preset weight are both set to be 0.

21. The method according to claim 1, wherein after the selecting a target allocation path according to the value of the loss function corresponding to each allocation path, comprising:
executing task scheduling according to the target allocation path; or
in response to a request for obtaining the target allocation path sent by a scheduling server, sending the target allocation path to the scheduling server to make the scheduling server execute the task scheduling according to the target allocation path.
